(19) United States
(12) Patent Application Publication
(10) Pub. No.: US 2026/0243894 A1
(43) Pub. Date: Aug. 20, 2026

(54) ELECTRONIC DEVICE, MOBILE APPARATUS, TRANSPARENT OBJECT DETECTION METHOD AND IMAGE CORRECTION METHOD

(71) Applicant: Sony Semiconductor Solutions Corporation, Kanagawa (JP)

(72) Inventors: Joseph SALINI, Shanghai (CN); Jiajun SHI, Shanghai (CN); Satoshi SUGIYAMA, Shanghai (CN)

(73) Assignee: Sony Semiconductor Solutions Corporation, Kanagawa (JP)

(21) Appl. No.: 19/144,962

(22) PCT Filed: Jan. 2, 2024
(86) PCT No.: PCT/CN2024/070124

§ 371 Date: Jul. 1, 2025

(30) Foreign Application Priority Data
Jan. 11, 2023 (CN) 202310041606.9

(51) Int. Cl. G01S 17/04; G01S 17/08; G01S 17/89; G06V 10/25; G06V 10/50; G06V 10/60; G06V 10/762

(52) U.S. Cl. CPC G01S 17/04; G01S 17/08; G01S 17/89; G06V 10/25; G06V 10/50; G06V 10/60; G06V 10/762

(57) ABSTRACT

This disclosure relates to an electronic device, a mobile apparatus with the electronic device, a transparent object detection method, and an image correction method. The electronic device therein may comprise a circuitry configured to obtain data of reflected radiation received in each pixel of an image captured by a ToF sensor, determine, based on the data of reflected radiation of each pixel in a first region of the image, a distribution of intensities of pixels in the first region, the intensity representing a peak of the data of reflected radiation of the pixel, and judge whether the image comprises a transparent object based on the distribution of intensities.

### CROSS REFERENCE TO RELATED APPLICATION

This application claims the benefit the Chinese Priority Patent Application No. 202310041606.9 filed with the China National Intellectual Property Administration on Jan. 11, 2023, the disclosure of which is incorporated herein by reference in its entirety.

### TECHNICAL FIELD

The present disclosure relates to an electronic device and a mobile apparatus having the electronic device, where the electronic device can be used with a ToF sensor. The electronic device of the present disclosure detects the presence of a transparent object (e.g., glass, window, etc.) in a capturing target of the mobile apparatus.

### BACKGROUND ART

In a mobile apparatus having an imaging device, detection of the presence or absence of a transparent object in a captured scene is generally necessary. Accurately recognizing transparent objects in a scene (for removal or segmentation from the scene) not only eliminates misinterpretation of the scene caused by the transparent objects, but also assists in other vision tasks such as target object detection and removal of image reflections, etc. For example, when an user wearing VR helmets and glasses, a vacuum robot or a delivery robot, or a motor vehicle is moving, if there are transparent obstacles such as large pieces of glass in the path of travel, it is difficult to recognize them with conventional RGB image sensors or even with the naked eye, which can lead to accidents.

In addition, in the case of autofocus when taking photographs, a mobile device (such as cameras, cellular telephones, robots and vehicles equipped with an imaging device, etc.) is equipped with an “autofocus” system, which allows it to focus on the main target of the scene (a person, an animal, a flower, etc.) when taking the photograph, such that clear photos can be obtained.

The current focusing techniques used in an imaging device are described below:

Contrast Detection Auto-Focus (CDAF): it performs autofocus by searching for the maximum contrast in an image. This is a common method in digital cameras, which however may be slower in finding the optimum status.

Phase Detection Auto-Focus (PDAF): it is a method that performs autofocus by sensing the phase difference in specific pixels with different microlens orientations. This method is faster to focus, but requires a specific sensor and can be difficult for some scenes.

Laser Detected Auto-Focus (LDAF): this method uses a proximity sensor to determine the distance to the target and adjusts the focus accordingly. While this method allows for fast and accurate focusing, the proximity sensor is prone to errors when there are transparent objects (reflective surfaces) in the path between the proximity sensor and the target. Such errors obviously result in the imaging device not focusing correctly.

Focusing technique using a depth sensor: autofocus is achieved by using a specific sensor, such as a direct Time of Flight (dToF) sensor or an indirect Time of Flight (iToF) sensor, to obtain distance (depth) data about the main target in the scene. This method can focus quickly, but it also requires the use of an external sensor. Moreover, this method is able to overcome the drawbacks encountered in the PDAF technique that some scenes are difficult to handle.

Additionally, certain scenarios can be challenging when detecting distance with a particular device, i.e., when the target is located behind a transparent object (e.g., glass, window, etc.). For example, when the imaging device is capturing a cityscape behind a window, an exhibit displayed in a glass case in a museum, etc., it may focus improperly on the window or glass.

Specifically, in a mobile apparatus using a depth sensor, the depth sensor may detect a distance to a transparent object rather than a distance to a target, especially if the distance between the imaging device and the target is long. This may be problematic when imaging, as the expected focus will be incorrect. Therefore, it becomes necessary to detect the presence of a transparent object in order to be able to exclude that transparent object from the depth data obtained, or to switch to another autofocus method to prevent this problem.

If the mobile apparatus has only the depth sensor or if the autofocus of the imaging device is dependent on depth, it would be useful to correct the depth data by removing the pixel depth data corresponding to the transparent object and replacing it with the depth data of the background object, i.e. correcting the depth data.

### SUMMARY OF INVENTION

To resolve the above problems, the present disclosure aims to detect the presence of transparent objects (e.g., glass, windows, etc.) using a depth sensor (specifically, a time-of-flight ToF sensor).

Therefore, the present disclosure proposes an electronic device. According to one example of the present invention, the electronic device comprises a module that may be implemented as a circuitry. The circuit is configured to obtain data of reflected radiation received in each pixel of an image captured by a ToF sensor, determine, based on the data of reflected radiation of each pixel in a first region of the image, a distribution of intensities of pixels in the first region, the intensity representing a peak of the data of reflected radiation of the pixel, and judge whether the image comprises a transparent object based on the distribution of intensities.

The circuit of the electronic device according to the present disclosure may be further configured to determine a degree of variation of the intensities of pixels in the first region according to the distribution of intensities, and judge whether the image comprises the transparent object based on the degree of variation.

The circuit of the electronic device according to the present disclosure may be further configured to judge the image comprises the transparent object when the degree of variation is higher than a predetermined threshold; and to judge the image doesn't comprise the transparent object when the degree of variation is lower than or equivalent to the predetermined threshold.

The circuit of the electronic device according to the present disclosure may be further configured to determine the degree of variation according to a maximum intensity Max_Intensity and at least one quantile intensity Quantile_Intensity in the intensities of pixels in the first region.

The circuit of the electronic device according to the present disclosure may be further configured to determine the degree of variation according to a maximum intensity Max_Intensity and one quantile intensity Quantile_Intensity in the intensities of pixels in the first region.

When the ToF sensor is a dToF sensor, the degree of variation is defined as a ratio calculated by

$$\frac{Max\_Intensity}{{Quantile\_Intensity}^{2}} .$$

When the ToF sensor is an iToF sensor, and the degree of variation is defined as a ratio calculated by

$$\frac{Max\_Intensity}{{( Quantile\_Intensity * distance )}^{2}} ,$$

wherein distance refers to a capturing distance of the iToF sensor.

The circuit of the electronic device according to the present disclosure may be further configured to detect a max intensity pixel in the image, and determine a selected area surrounding the max intensity pixel as the first region.

The circuit of the electronic device according to the present disclosure may be further configured to detect a max intensity pixel in a region of interest in the image, and determine a selected area surrounding the max intensity pixel as the first region.

According to the present disclosure, when the ToF sensor is a dToF sensor, a peak in a histogram of pixel in the dToF sensor corresponds to the intensity, and the circuitry of the electronic device may be configured to detect, from the image, one or more pixels with more than one peak in the histograms, select a max intensity pixel from the one or more pixels, and determine a selected area surrounding the max intensity pixel as the first region. Preferably, the circuit may be further configured to select the max intensity pixel from pixels with more than one peak in a region of interest in the image.

The circuit of the electronic device according to the present disclosure may be further configured to determine a position distribution of pixels with different intensities in the first region when a result of the judging shows detection of a transparent object, and to correct the result of the judging based on the position distribution.

The circuit of the electronic device according to the present disclosure may be further configured to determine the position distribution by calculating I_{y}/Iₓ, wherein Iₓ=Σmr_{y}², m is an intensity of each of the pixels in the first region, r_{y} is a distance from the pixel to a first principal axis y of rotation of the first region, and I_{y}=Σmrₓ², m is an intensity of each of the pixels in the first region, rₓ is a distance from the pixel to a second principal axis x of rotation of the first region, and wherein I_{y}>Iₓ. Wherein when I_{y}/Iₓ is larger than or equivalent to a predetermined threshold, the circuitry is configured to determine that there is no transparent object, and to correct the result of the judging.

The circuit of the electronic device according to the present disclosure may be further configured to, before determining the distribution of intensities, pre-process the data of reflected radiation of each pixel to remove a data of reflected radiation representing a cover glass of the ToF sensor.

According to the present disclosure, when the ToF sensor is a dToF sensor, a peak in a histogram of pixel in the dToF sensor corresponds to the intensity, and wherein the circuitry of the electronic device is further configured to: get all pixels with more than one peak in the image, when the result of judging shows detection of transparent object, regroup the all pixels with more than one peak into a plurality of clusters based on distance data of pixels in the image, the plurality of clusters corresponding to different distances respectively, select a cluster from the plurality of clusters that correspond to the transparent object as a transparent object cluster, and remove the first peaks of the pixels in the transparent object cluster from the image, or output a depth corresponding to the first peak of the pixel in the transparent object cluster as a distance to the transparent object and output a depth corresponding to a second peak of the pixel in the transparent object as a distance to a target.

The electronic device according to the present disclosure may be implemented as the ToF sensor.

An electronic device according to another aspect of the present disclosure is further proposed. The electronic device may comprise a circuitry configured to: obtain a histogram of each pixel in an image captured by a dToF sensor, get all pixels with 2 peaks in the histogram, obtain a first set of pixels from the all pixels with 2 peaks, the first set of pixels being pixels where first peak is the highest peak, and remove the first peaks of the first set of pixels from the image.

The circuit of the electronic device according to the present disclosure is further configured to, before getting the all pixels with 2 peaks, pre-process the histogram of each pixel to remove a peak representing a cover glass of the dToF sensor from histogram.

The circuit of the electronic device according to the present disclosure is further configured to select, from the all pixels with 2 peaks, pixels corresponding to a transparent object, and select, from the pixels corresponding to a transparent object, one or more pixels with the first peak being the highest peak, as the first set of pixels

The circuit of the electronic device according to the present disclosure is further configured to regroup the all pixels with 2 peaks into a plurality of clusters based on distance data of the pixels in the image, the plurality of clusters corresponding to different distances respectively, select, from the plurality of clusters, a cluster that corresponds to a transparent object, and select, from the cluster that corresponds to the transparent object, one or more pixels with the first peak being the highest peak, as the first set of pixels.

In the electronic device according to the present disclosure, the transparent object is determined based on a distribution of intensities of pixels in a first region of the image, the intensity representing a peak of data of reflected radiation received by the pixel.

A mobile apparatus according to another aspect of the present invention is further proposed, the mobile apparatus comprising the above-described electronic device.

The mobile apparatus according to the present disclosure is an imaging apparatus, wherein an auto-focus unit of the imaging apparatus is configured to perform auto-focusing based on a result of judging of the electronic device, and wherein the auto-focus unit is configured to auto-focus on a background of a transparent object, when the result of judging of the electronic device shows detection of the transparent object.

The mobile apparatus according to the present disclosure is a mobile phone.

In the mobile apparatus according to the present disclosure, the imaging apparatus comprises the ToF sensor, the imaging apparatus corrects a depth map generated by the ToF sensor based on a result of judging of the electronic device, and wherein the auto-focus unit is configured to perform auto-focusing based on the corrected depth map.

The mobile apparatus according to the present disclosure is a vehicle, a Virtual Reality (VR) eyeglasses/helmet, or a self-mobile robot.

A transparent objection detection method according to a further aspect of the present disclosure is proposed. The method may comprise: obtaining data of reflected radiation received in each pixel of an image captured by a ToF sensor, determining, based on the data of reflected radiation of each pixel in a first region of the image, a distribution of intensities of pixels in the first region, the intensity representing a peak of the data of reflected radiation of the pixel, and judging whether the image comprises a transparent object based on the distribution of intensities.

According to the transparent objection detection method of the present disclosure, a degree of variation of the intensities of pixels in the first region is determined according to the distribution of intensities, and whether the image comprises the transparent object is judged based on the degree of variation.

According to the transparent objection detection method of the present disclosure, it is judged that the image comprises the transparent object when the degree of variation is higher than a predetermined threshold; and it is judged that the image doesn't comprise the transparent object when the degree of variation is lower than or equivalent to the predetermined threshold

According to the transparent objection detection method of the present disclosure, the degree of variation is determined according to a maximum intensity Max_Intensity and at least one quantile intensity Quantile_Intensity in the intensities of pixels in the first region.

According to the transparent objection detection method of the present disclosure, the degree of variation is determined according to a maximum intensity Max_Intensity and one quantile intensity Quantile_Intensity in the intensities of pixels in the first region.

According to the transparent objection detection method of the present disclosure, the ToF sensor is a dToF sensor, and the degree of variation is defined as a ratio calculated by

$$\frac{Max\_Intensity}{{Quantile\_Intensity}^{2}} .$$

According to the transparent objection detection method of the present disclosure, the ToF sensor is an iToF sensor, and the degree of variation is defined as a ratio calculated by

$$\frac{Max\_Intensity}{{( Quantile\_Intensity * distance )}^{2}} ,$$

wherein distance refers to a capturing distance of the iToF sensor.

The transparent objection detection method according to the present disclosure further comprises detecting a max intensity pixel in the image, and determining a selected area surrounding the max intensity pixel as the first region.

The transparent objection detection method according to the present disclosure further comprises detecting a max intensity pixel in a region of interest in the image, and determining a selected area surrounding the max intensity pixel as the first region.

According to the transparent objection detection method of the present disclosure, the ToF sensor may be a dToF sensor, and a peak in a histogram of pixel in the dToF sensor corresponds to the intensity, and the method further comprises: detecting, from the image, one or more pixels with more than one peak in the histograms, selecting a max intensity pixel from the one or more pixels, and determining a selected area surrounding the max intensity pixel as the first region.

The transparent objection detection method according to the present disclosure further comprises selecting the max intensity pixel from pixels with more than one peak in a region of interest in the image.

The transparent objection detection method according to the present disclosure further comprises determining a position distribution of pixels with different intensities in the first region when a result of the judging shows detection of a transparent object, and correcting the result of the judging based on the position distribution.

The transparent objection detection method according to the present disclosure further comprises determining the position distribution by calculating I_{y}/Iₓ, wherein Iₓ=Σmr_{y}², and I_{y}=Σmrₓ², m is an intensity of each of the pixels in the first region, rₓ is a distance from the pixel to a first principal axis x of rotation of the first region, r_{y} is a distance from the pixel to a second principal axis y of rotation, and wherein I_{y}>Iₓ.

The transparent objection detection method according to the present disclosure further comprises determining that there is no transparent object when I_{y}/Iₓ is larger than or equivalent to a predetermined threshold, and correcting the result of the judging.

The transparent objection detection method according to the present disclosure further comprises before determining the distribution of intensities, pre-processing the data of reflected radiation of each pixel to remove a data of reflected radiation representing a cover glass of the ToF sensor.

According to the transparent objection detection method of the present disclosure, the ToF sensor is a dToF sensor, a peak in a histogram of pixel in the dToF sensor corresponds to the intensity, and the method further comprising: getting all pixels with more than one peak in the image when the result of judging shows detection of transparent object, the plurality of clusters corresponding to different distances respectively; regrouping the all pixels with more than one peak into a plurality of clusters based on distance data of the pixels in the image; selecting a cluster from the plurality of clusters that correspond to the transparent object as a transparent object cluster; and removing the first peak of the pixel in the transparent object cluster from the image or outputting a depth corresponding to the first peak of the pixel in the transparent object cluster as a distance to the transparent object and outputting a depth corresponding to a second peak of the pixel in the transparent object cluster as a distance to a target.

An image correction method according to a still further aspect of the present invention is proposed. The method comprises: obtaining a histogram of each pixel in an image captured by a dToF sensor, getting all pixels with 2 peaks in the histogram, obtaining a first set of pixels from the all pixels with 2 peaks, the first set of pixels being pixels where first peak is the highest peak, and removing the first peaks of the first set of pixels from the image.

The image correction method according to the present disclosure further comprises, before getting the all pixels with 2 peaks, pre-processing the histogram of each pixel to remove a peak representing a cover glass of the dToF sensor from histogram.

The image correction method according to the present disclosure further comprises selecting, from the all pixels with 2 peaks, pixels corresponding to a transparent object, and selecting, from the pixels corresponding to a transparent object, one or more pixels with the first peak being the highest peak, as the first set of pixels.

The image correction method according to the present disclosure further comprises: regrouping the all pixels with 2 peaks into a plurality of clusters based on distance data of the pixels in the image, the plurality of clusters corresponding to different distances respectively; selecting, from the plurality of clusters, a cluster that corresponds to a transparent object; and selecting, from the cluster that corresponds to a transparent object, one or more pixels with the first peak being the highest peak, as the first set of pixels.

According to the image correction method of the present disclosure, the transparent object is determined based on a distribution of intensities of pixels in a first region of the image, the intensity representing a peak of data of reflected radiation received by the pixel. An electronic device according to the present disclosure is capable of detecting the presence of a transparent object in an image captured by a ToF sensor. This is highly beneficial in a mobile apparatus having an imaging device. The electronic device of the present disclosure enables the imaging device to appropriately perform autofocus based on the detection of transparent objects, thereby obtaining a clear image of the target object. In addition, the electronic device of the present disclosure is capable of recognizing transparent objects in a scene, thereby assisting in removing or segmenting the transparent objects from the scene.

Detailed embodiments of the present disclosure will be described below with reference to the figures.

### BRIEF DESCRIPTION OF DRAWINGS

FIG. 1 is an explanatory diagram showing a histogram of a pixel of a dTof sensor.

FIG. 2 is an explanatory diagram showing a histogram of a pixel when there is a transparent object according to an example of the present disclosure.

FIG. 3 is an explanatory diagram showing a particular example according to \textcircled{2} in row C of FIG. 2.

FIG. 4 is an explanatory diagram showing distance measurement principle of an iToF sensor.

FIG. 5 is a further explanatory diagram showing distance measurement principle of an iToF sensor.

FIG. 6 is an explanatory diagram showing dToF sensor data of different materials according to an example of the present disclosure.

FIG. 7 is a graph illustrating the pixel intensity distribution of the different materials in the rightmost column of FIG. 6.

FIG. 8 is an explanatory diagram illustrating selection of a quantile value according to the present disclosure.

FIG. 9 is an explanatory diagram illustrating the variation of the quantile value ratios of different materials in FIG. 6 with distance.

FIG. 10 is an explanatory diagram showing iToF sensor data of different materials according to an example of the present disclosure.

FIG. 11 is an explanatory diagram illustrating the variation of the quantile value ratios of different materials in FIG. 10 with distance.

FIG. 12 is an explanatory diagram illustrating dToF depth data of a glass and an edge according to an example of the present disclosure.

FIG. 13 is an explanatory diagram showing distribution of pixel intensities of the glass and the edge in FIG. 12.

FIG. 14 is an explanatory depth map obtained from the dToF sensor according to an example of the present disclosure.

FIG. 15 is an explanatory diagram illustrating the correction of a depth map according to an example of the present disclosure.

FIG. 16 is an explanatory diagram illustrating an Region of Interest according to an example of the present disclosure.

FIG. 17 is a block diagram illustrating an electronic device and a mobile apparatus according to an example of the present disclosure.

FIG. 18 is a block diagram illustrating a mobile device according to another example of the present disclosure.

### DESCRIPTION OF EMBODIMENTS

Hereinafter, preferred embodiments of the present disclosure are described in detail with reference to the drawings. Unless otherwise indicated, the same reference signs are used to denote the same or equivalent components.

### [ToF Sensor]

The commonly used depth sensor includes dToF sensors and iToF sensors, among others. The present disclosure proposes to utilize the data of reflected radiation from an object obtained by the dToF sensor or the iToF sensor to detect whether or not a transparent object is present. More specifically, the transparent object detection is performed by utilizing a peak (i.e., “intensity”) of the data of reflected radiation received by each pixel in a pixel array of the ToF sensor. The intensity of a pixel corresponds to the maximum value of the amount of light (i.e., the amount of radiation) returned to and received by that pixel. Since the dToF sensor and the iToF sensor detect a depth of the target object with different principles, they are described separately in the following.

dToF Sensor

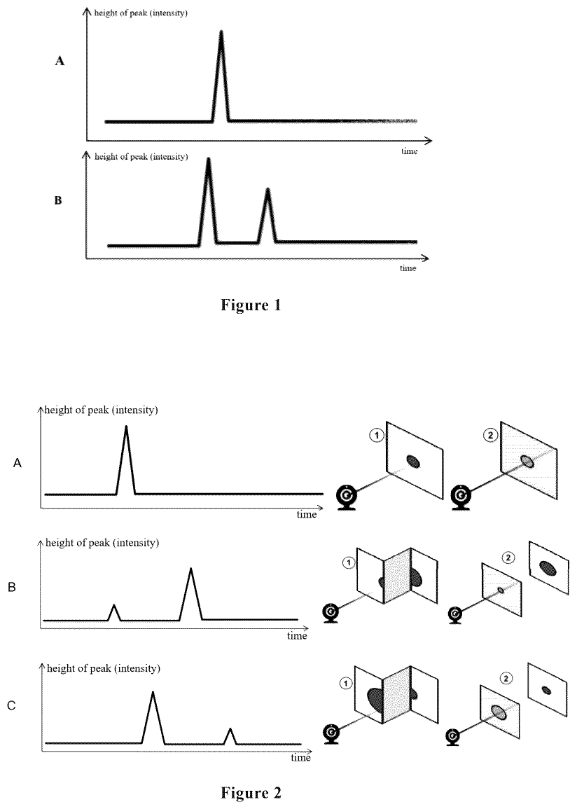

The dToF sensor measures a depth (distance) of a scene by directly capturing the time during which the light triggered by an illuminator returns to the sensor, thereby capturing the time of flight of the photons. This measurement is conducted by counting, for each pixel of the sensor, the number of photons received in different time periods (called time bins, bin) and deriving a histogram for each pixel. The histogram is the photon count over time, with time as the horizontal axis and photon count as the vertical axis. When there is no transparent object in the imaging target, there is a maximum value (i.e., a peak) in the histogram of the pixel, as shown in A of FIG. 1. The value of the horizontal axis corresponding to this peak represents the time during which the light from the illuminator strikes the object and returns. The distance of the object is then obtained using the speed of light. Thus, a depth map of the dToF sensor consisting of the distance (depth) of each pixel is obtained. In the case where the target is located behind a transparent object, due to the transmission and reflection, the histogram of pixels will contain more than one local maximum value (i.e., more than one peak), including a peak from the transparent object (the first peak shown in B of FIG. 1) and a peak from the object behind the transparent object (the second peak shown in B of FIG. 1). The horizontal axis of the histogram in FIG. 1 represents time, and the vertical axis represents peak height (also referred to as “intensity”). The histograms in FIGS. 1 and 2 show a peak that is spike rather than a column. This is because the peak corresponds to a time bin, which is a time period, and the spike represents the trend of the histograms at numerous time points within that time period. As a result, the histogram of the dToF sensor appears spiky.

When there are transparent object and background object in the scene, the depth of both can be detected by the dToF sensor and can be detected at the same time. In this case, two peaks may appear in the histogram of a single pixel, indicating a transparent object and a background object, respectively. The depth map obtained by a dToF sensor is generated from the maximum intensity of each pixel (i.e., the maximum peak in the pixel histogram), and as a result, when the peak indicating the transparent object is the maximum peak in the pixel histogram, autofocus performed with the depth map obtained by the dToF sensor will improperly focus on the transparent object instead of the target (background object). Furthermore, the presence of two peaks in a single pixel also affects the ranging function of the ToF sensor, i.e., the peak corresponding to the distance to the target object cannot be identified. Therefore, it is necessary to detect transparent objects in the scene.

In the case of a camera, for example, when there is a transparent object in the target, it is necessary to consider using the dToF sensor to detect the transparent object in two different situations. In one situation, the transparent object is glass, transparent resin, plastic, or a window, and the target in the background is located too far behind the glass to be detected by the dToF sensor. In this case, it is obvious to avoid using the depth data measured by the dToF sensor for camera autofocus. In the other situation, the target as the background can be detected by the dToF sensor, but the depth map includes depth data indicating the distance to the glass or window. When this data is used for autofocus, there is a risk that the camera's imaging performance will be severely degraded. Therefore, it is necessary to correct the depth map (i.e., to remove the pixel data indicating transparent objects) and to perform autofocus using the corrected depth map.

The present disclosure proposes to utilize the data of pixel histogram of the dToF sensor to determine the presence or absence of a transparent object.

Specifically, when the histogram of pixels has only one peak (as shown at the left side in row A of FIG. 2), the peak indicates two possible scenarios. One is the real target (see \textcircled{1} at right side in row A of FIG. 2); the other is a transparent object (see \textcircled{2} at right side in row A of FIG. 2), whereas the real target (i.e., the background object) is too far away to be detected by the dToF sensor (for example, the cityscape far outside the window).

When there are two peaks in the histogram of pixels and the first peak is the smaller of the two (as shown at the left side in row B of FIG. 2), there are also two possible scenarios. One is there is no transparent object in the target, but rather an edge (such as a doorframe, a wall corner or the like), see \textcircled{1} at the right side in row B of FIG. 2; the other is a transparent object present in the target, see \textcircled{2} at the right side in row B of FIG. 2).

When there are two peaks in the histogram of pixels and the first peak is the larger of the two (as shown at the left side in row C of FIG. 2), there are also two scenarios. Similarly to the above, one is there is no transparent object in the target, but rather an edge, see \textcircled{1} at the right side in row C of FIG. 2; and the other is a transparent object present in the target, see \textcircled{2} at the right side in row C of FIG. 2.

The intensities of the first peaks at B and C in FIG. 2 are different, which represent the edges shown in \textcircled{1} of B and C, respectively, and the peak intensity of the edge in B is lower. This is because the number of photons hitting the edge and returning in B is lower, and the returned number of photons may depend on the angle between the light emitter and the edge, the reflectivity of the edge material, and so on.

The presence of a transparent object (for example a glass) is indicated in \textcircled{2} at the right sides of both B and C in FIG. 2. The intensity of the transparent object is lower in B, while the intensity of the transparent object is higher in C. This depends, at least in part, on the transmittance of the different transparent objects, the number of photons returned from a glass with the higher transmittance being lower. Also, it can be partly influenced by dust on the glass or other substances that may reflect light. Meanwhile, it may be affected by the intensity of the light of the irradiation source. When the intensity of the light from the irradiation source is high, the number of photons returned from the target is correspondingly high, and vice versa.

It should be noticed that a peak may also be present at a position very close to the start time in the histogram of pixels, which is the photon data returned from the cover glass of the camera. According to the technical solution of the present disclosure, the acquired histogram data has been preprocessed to remove the peak very close to the start time to avoid the influence of the cover glass. Also, in a particular embodiment where a camera having a double-layer cover glass is used, two peaks that are very close to each other will appear in the histogram of pixels at positions that are very close to the start time. In this case, according to the technical solution in the context of the present disclosure, during preprocessing of the histogram data of the pixels, if two peaks are detected at the position very close to the start time and the distance is less than a predetermined threshold (for example, 20 mm), the electronic device of the present disclosure considers the two peaks as corresponding to a peak of the cover glass, and removes the two peaks from the histogram data before proceeding to the subsequent processing. In addition, the case where the transparent object is a single thicker layer glass or consists of two or three layers in close proximity is considered. In embodiments according to the present disclosure, depending on the resolution mode of the ToF sensor (about 6 cm), the aforementioned transparent object will still have only one peak in the histogram of pixels.

In the case shown in row A in FIG. 2, it is necessary to judge whether or not there is a transparent object in the imaging target, i.e., to judge whether or not it is the case in \textcircled{2} at right side of row A. In this case, the target is too far away to be detected by the sensor. At this time, it is necessary to avoid using depth data for autofocusing in the camera and to use another autofocus method (for example, CDAF) in the camera. In other mobile apparatus such as a robot vacuum cleaner, it is necessary to use a depth sensor and perform actions such as avoidance based on a judgment that a transparent object has been detected. It will be explained in detail later how the presence or absence of a transparent object is determined in the case shown in row A of FIG. 2.

In the case shown in row B of FIG. 2, the intensity of the transparent object (i.e., the first peak) is relatively low. As described above, the depth map of the dToF sensor is generated from the maximum intensity of each pixel, and therefore, the presence of a transparent object in this case has relatively less effect on the autofocus action based on the depth map. However, it is still beneficial to detect the transparent object and remove the depth of the pixel indicating the transparent object from the depth map, and use the corrected depth map for operations such as autofocusing. In addition, detecting the transparent object enables the dToF sensor to correctly determine the distance to the target object (as well as the distance to the transparent object).

In the case shown in row C of FIG. 2, due to the large intensity of the transparent object (i.e., the first peak), if the depth map is used for autofocus, it may incorrectly focus on the transparent object instead of the background object (i.e., the target of the imaging). Therefore, it is necessary to judge whether it is the case shown in row C of FIG. 2 and to correct the depth map.

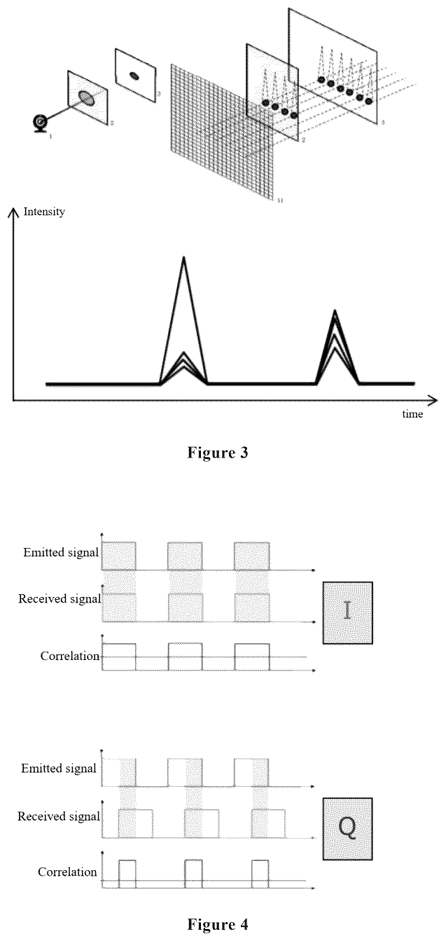

FIG. 3 illustrates a particular example for the situation shown in row C in FIG. 2. In FIG. 3, the upper part illustrates a camera 1, a pixel grid 11 of the camera, a transparent object 2, and a background wall 3. The lower part of this figure illustrates the histogram data of four adjacent pixels in the pixel grid that detect the transparent object. As shown in the pixel histogram in the lower art of FIG. 3, in the pixels that detect the transparent object (i.e., the first peak), the difference between the intensity of the maximum intensity pixel and the intensities of the other pixels adjacent to the maximum intensity pixel is large; whereas in the peaks that represent the background wall, the difference between the intensity of the maximum intensity pixel and the intensities of the other pixels adjacent to the maximum intensity pixel wall is small. That is to say, the distribution of intensities of pixels obtained on the basis of the pixel histogram is different for transparent objects compared to non-transparent objects. The inventors have discovered and firstly proposed that it is possible to judge the presence or absence of a transparent object based on the distribution of intensities of pixels.

iToF Sensor

The iToF sensor obtains the depth (distance) of a target by emitting a modulated infrared light signal to the scene, and then receives the light signal reflected back from the target in the scene. For example, as shown in FIG. 4, the distance of a target can be estimated by emitting the following two signals to the target and detecting the correlation signals of the received signals returned therefrom. The two signals are:
I: “In Phase” signal
Q: “Quadrant phase” signal with 90 degree offset

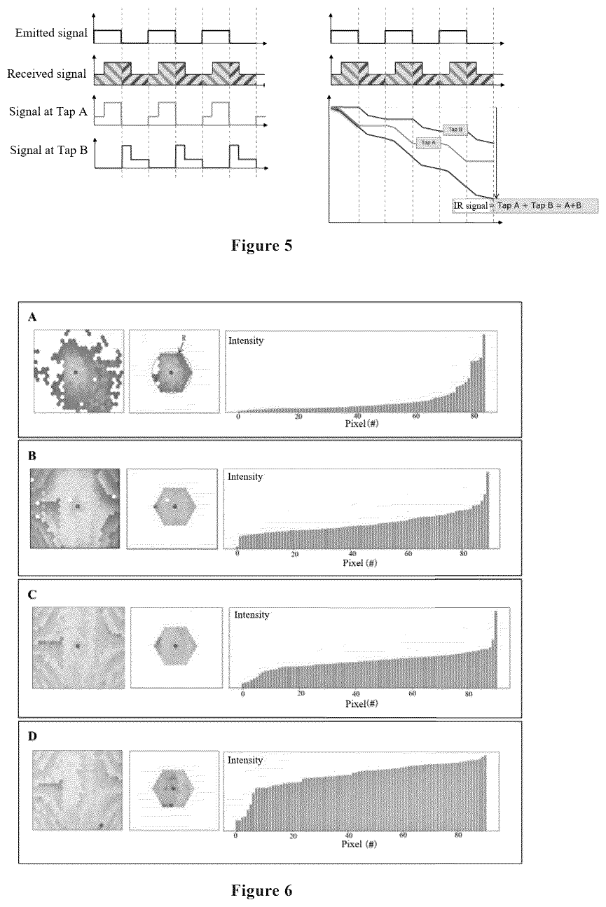

The correlation signal is obtained using a CPAD (Current Assisted Photonic Demodulator). The received light is “collected” in two different “taps”, generally referred to as Tap A and Tap B (shown on the left in FIG. 5). The signal difference between Tap A and Tap B gives the correlation signal of the signal from the radiator. This correlation signal is the ToF signal of the iToF sensor. That is to say, TOF signal=Tap A−Tap B. Thereby, the TOF signals of the I and Q signals can be obtained by the respective tap signals Tap A and Tap B:

$$ITOF = Tap A - Tap B ( phase shift = 0 )$$

$$QTOF = Tap A - Tap B ( phase shift = 90 degrees )$$

The sum of the absolute values of ITOF and QTOF represents the confidence “C”), i.e., C=|ITOF|+|QTOF|. The confidence C for each pixel in the array of pixels of the iToF sensor represents the amount of active light returning to that pixel. In the present disclosure, similar to the dToF sensor, the amount (i.e., the confidence C) of the active light (i.e., radiation emitted by the radiator) that is returned to the pixel is referred to as the “intensity” of the pixel of the iToF sensor.

In addition, the sum of Tap A and Tap B gives the total amount of light (both ambient light and active light) received by the sensor, i.e., the global IR (infrared) image, as shown on the right in FIG. 5. That is, IR signal=Tap A+Tap B. The IR signal of each pixel in the pixel array of the iToF sensor represents the total amount of active and ambient light returning to that pixel. Therefore, it is also referred to as the “intensity” of the pixel.

The pixel “intensity” represented by the confidence C and the IR signal, as well as the resulting confidence image and the infrared image can be used for the detection of transparent object as will be described below.

### [Principle for Transparent Object Detection]

Transparent Object Detection Using a dToF Sensor Data

The inventors analyzed the distribution of intensities of pixels (i.e., peak heights in a pixel histogram) for different materials (including glass, whiteboards, elevators, marble, display screens, white walls, etc.). In this case, glass represents transparent objects, while other materials (non-transparent objects) were selected from common objects with a smooth surface.

Here, for illustration purposes, the results for only four materials including glass (transparent object) have been selected for discussion. The results are shown in FIG. 6. Row A in FIG. 6 represents glass, row B represents elevator (elevator door surface), row C represents marble, and row D represents white wall. The dToF sensor data of the surfaces of the above materials were acquired separately (the images shown in the left column in FIG. 6, which is a pixel intensity map). The histogram data of all the pixels in the images is detected to obtain a pixel with the highest intensity (i.e., the pixel with histogram having the highest peak). As stated above, before detecting the highest-intensity pixel, the histogram of the pixel is pre-processed to remove peak indicating, for example, the camera cover glass. Thus, the histogram of each pixel has only one peak (corresponding to the surface of the material being photographed).

An area surrounding the highest-intensity pixel is selected as a selected region. For example, as shown in the middle column of FIG. 6, an area centered on the highest-intensity pixel with a radius of R (R is the number of pixels) around that center pixel is selected as the selected region. In the example shown in FIG. 6, R is selected as 5 pixels. The intensities of all pixels in the selected region are ranked, for example, in order from low to high, such that an intensity distribution of different materials is obtained as shown in the right column in FIG. 6. The radius R of the selected region is not limited to 5 pixels. However, if the value of R is too small, the pixel intensity distribution of the material cannot be clearly presented, while if the value of R is too large, the intensity distribution of the material may not be appropriately characterized in the calculations as will be described below. In a particular embodiment according to the present disclosure, a dToF sensor having a pixel array of 24*24 is used, and the range of R is set to 3 to 8 pixels, preferably 5 pixels. Of course, R is not limited to a particular value or range, but can be adaptively selected, in the calculation of a predetermined threshold as will be described below, depending on different sensors and test situations.

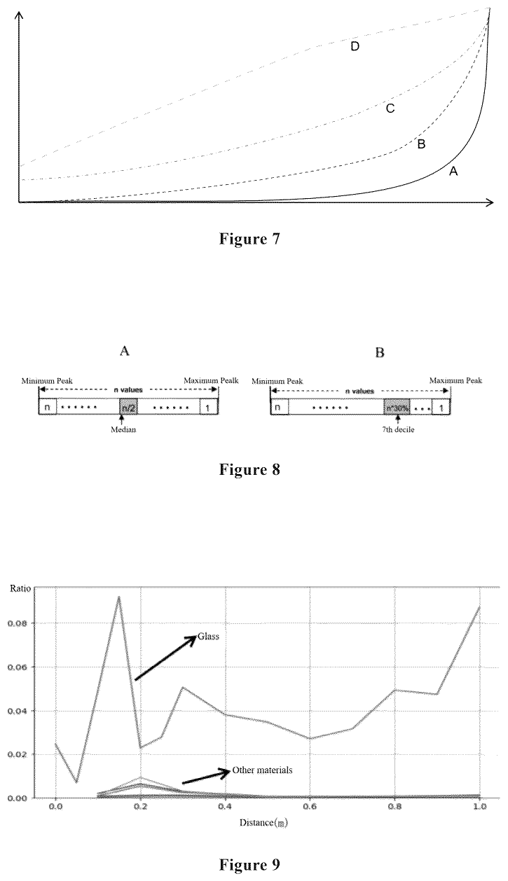

Based on the distribution of intensities shown in the right column of FIG. 6, it can be visualized that the intensity distribution of glass (A in FIG. 6), i.e., transparent object, is remarkably different from that of other materials. The same conclusion can be drawn in the graph shown in FIG. 7. FIG. 7 corresponds to the intensity distribution of the right column in FIG. 6 and reflects in the form of curves the intensity distribution of the four different materials shown in the right column of FIG. 6. In this case, the curve A in FIG. 7 reflects glass.

With reference to the distribution of intensity of pixels for different materials shown in FIGS. 6 and 7, the inventors propose that the distributions of intensities for the different materials can be characterized with a view to distinguishing a transparent object (glass) from other materials. In other words, the degree of difference in pixel intensity of different materials is shown by characterizing the intensity distribution (curve) as shown in FIG. 6 or FIG. 7 to distinguishing glass from other materials.

The inventors have found that glass (transparent object) can be successfully distinguished from these materials in a simple and effective manner using a particular ratio characterizing the intensity distribution. For example, a ratio between the maximum intensity and a quantile intensity with a power (e.g., a power of 2) of the intensities of pixels in a selected region is used. Specifically, among the pixel intensities of the selected region described above, a maximum value intensity, Max_Intensity, and a quantile value intensity, Quantile_Intensity, between the maximum intensity (the highest peak) and the minimum intensity (the smallest peak) are selected. The quantile value intensity, Quantile_Intensity, may be selected, for example, as an median quantile intensity (A in FIG. 8), the 7^{th} decile intensity, 7^{th} decile_Intensity (B in FIG. 8) and so on.

The selection of quantile values is obviously not limited to these two values, but can be selected as any quantile between the maximum and minimum intensities, as long as the intensity distribution is properly characterized.

Then, a calculation is conducted based on the following Formula 1

$$\frac{Max\_Intensity}{{Quantile\_Intensity}^{2}} \qquad ( Formula 1 )$$

For example, the median quantile value Median_Intensity, more specifically, the 5^{th} decile value 5^{th} decile_Intensity, is used for measurements on the different materials described above. Specifically, the inventors took pictures of the above-described materials at different distances (e.g., 0.1 m, 0.2 m, 0.3 m, 0.4 m, 0.5 m, 0.6 m, 0.7 m, 0.8 m, 0.9 m, and 1 m as shown in FIG. 9) using a dToF sensor, respectively, to obtain the ToF data of the materials at different distances. Based on the pixel histogram data in the ToF data, the intensity distributions of the materials at the corresponding distances were obtained according to the embodiment shown in FIG. 6. Then, based on the maximum value intensity Max_Intensity and the median quantile intensity Median_Intensity, the ratios at the corresponding distances were obtained by Formula 1 above. The results are shown in FIG. 9.

As shown in FIG. 9, at each of different distances for imaging, the ratio for glass is significantly higher than the ratios for other materials. As a result, the inventors propose that a threshold value can be predetermined and the presence or absence of a transparent object in the imaging target can be determined by this threshold value. For example, in this particular embodiment, i.e., the median_intensity Median_Intensity is used to calculate the ratio based on Formula 1, and the threshold value is chosen to be 0.015. The inventors have conducted a large number of different tests, and the glass has been successfully distinguished from other materials through the calculation of Formula 1 described above and the comparison of the calculated result with the threshold value. Of course, the threshold value is not limited to a particular value, but rather the threshold value or range of threshold values may be selected in the interval from 0 to 0.02 (excluding 0) in the particular embodiment as shown in FIG. 9. The threshold value or threshold range may be stored in advance in an electronic device according to the present disclosure, or in a ToF sensor or a mobile apparatus comprising the ToF sensor.

Similarly, the 7th decile value 7^{th} decile_Intensity was also used in the calculation for the different materials mentioned above (results not shown). The results show that when the threshold value was chosen to be in the range of 0.002 to 0.008, the glass was distinguished from the other materials with an even higher success rate. In this particular embodiment, selecting the threshold to be 0.006 is optimal. In summary, in this embodiment, the optimal result of distinguishing the glass was obtained when using the 7th decile of the decile, 7thdecile_Intensity, as the Quantile_Intensity in Equation 1. Therefore, in this particular embodiment, the quantile intensity Quantile_Intensity in Formula 1 is preferably 7thdecile_Intensity.

In sum, in this example, when the 7th decile value, 7^{th} decile_Intensity, is used as the Quantile_Intensity in Formula 1, an optimal result for discriminating the glass is obtained. Therefore, in this particular example, the Quantile_Intensity of the quantile value in Formula 1 is preferably 7^{th} decile_Intensity.

Further, the power value of the quantile strength in Formula 1 is not limited to 2. The inventors have also used 3 as the power value of the quantile strength. However, in this particular example according to the present disclosure, a power value of 2 gives superior results with less arithmetic.

Still further, with respect to the denominator in Formula 1, an intensity value other than the quantile value can also be used, for example, an average value which is obtained based on the pixel intensities in the selected region after removing the maximum intensity therefrom (in order to minimize the effect of the maximum intensity on the average value as well as on the ratio calculation). The average value is used as the denominator in Formula. It should be understood that the example using the quantile intensity is relatively preferable due to the free selection on different quantile intensities according to different situations. Hereinafter, the description will also be based on this example.

In the above-described example for characterizing the intensity distribution, two pixel intensity values are selected from the pixel intensities in the selected region. However, the characterization of the intensity distribution is not limited to the above-described example. For example, more than two values of the pixel intensities may be used to characterize the degree of variation of the pixel intensities. The transparent object detection may also be performed using a pixel distribution characterized by a reference curve.

For example, three values from pixel intensities, Max_Intensity, Median_Intensity, and the 7^{th} decile_Intensity, can be used. In this case, the ratio can be calculated using Formula 2 below.

$$\frac{Max\_Intensity}{0.5 * {Median\_Intensity}^{2} + 0.5 * 7 th {decile\_Intensity}^{2}} \qquad ( Formula 2 )$$

Similarly, four values from pixel intensities, Max_Intensity, Median_Intensity, the third decile intensity, 3^{rd} decile_Intensity, and the 7th decile intensity, 7^{th} decile_Intensity, can be used. In this case, the ratio can be calculated using Formula 3 below.

$$( Formula 3 )$$

$$\frac{Max\_Intensity}{\begin{matrix}0.3333 * 3 rd {decile\_Intensity}^{2} + 0.3333 * {Median\_Intensity}^{2} + \\ 0.3333 * 7 th {decile\_Intensity}^{2}\end{matrix}}$$

However, the presence or absence of a transparent object can be determined, most simply, fast and effective, by using Formula 1 with two of the pixel intensity values.

The determined threshold will be different when a different pixel intensity value or a different number values of pixel intensities is used. These thresholds may be pre-calculated and stored in an electronic device of the present disclosure. Optionally, they may also be stored in a ToF sensor or a mobile apparatus (e.g., cell phone, camera, self-moving robot) that includes a ToF sensor.

It should be noticed that the spirit of the present disclosure is to recognize transparent objects by characterizing the distribution of intensities of pixels obtained via a ToF sensor. Therefore, the formulas described above are only preferred embodiments and are not intended to limit the present invention. The characterization of the distribution of intensities of pixels is not limited to the above-mentioned formulas, and other calculation methods capable of characterizing the intensity distribution (curve) may also be used. For example, a correlation operation is performed by correlating a predetermined peak in the distribution of intensities in a selected region as described above obtained by the ToF sensor with a predetermined peak in the distribution of intensities in said selected region of a typical transparent object material (e.g., glass). If the correlation factor obtained is greater than a threshold value, then the detected distribution of intensities is considered to be similar to the distribution of intensities of the glass, and the glass is determined to be detected.

It should further be noticed that the test results may be different when using different ToF sensors. Therefore, the selection of the specific thresholds described above is not limiting. In the specific implementation of the present disclosure, pre-testing may be performed based on the specific ToF sensor to be used, and then the threshold data specialized to that ToF sensor is obtained.

### The Maximum Intensity Pixel

In the example for the dToF sensor as described above, a surface of the different materials is imaged directly so that only one peak existed in the histogram of the pixels. Then, a maximum intensity pixel (referred to as a “global maximum intensity pixel”) was selected from the global pixel intensity map of all pixels.

However, when imaging in reality with a dToF sensor, more than one peak may appear in the histogram of pixels. If pixels with more than one peak (for example, B and C in FIG. 2) are detected in the pixel histogram, the pixels with more than one peak are assumed to be “transparent pixels”. All “transparent pixels” from the global pixel intensity map are selected, and a “transparent pixel” with the maximum intensity is detected. Then, a region surrounding the “transparent pixel” with the maximum intensity is selected as a selected region (e.g., a region of radius R centered on the maximum intensity pixel as described above for the global pixel intensity), and the distribution of intensities of pixels in the selected region is determined. Subsequently, the distribution of intensities based on “transparent pixel” with the maximum intensity is characterized in a manner similar to the characterization of the distribution of intensities based on the global maximum intensity pixel as described above.

In addition, when the dToF sensor is used for actual imaging and transparent object detection, in the selection of the maximum intensity pixel, only the global maximum intensity pixel may be selected. In the case where a “transparent pixel” exists, either of the global maximum intensity pixel and the maximum intensity “transparent pixel” may be selected, and preferably, the maximum intensity “transparent pixel” is selected.

It is also preferred that, in the case of the presence of a “transparent pixel”, the maximum intensity pixel is first selected from the global pixel intensity data of all the pixels, and the ratio is calculated based on the above-described formula characterizing the intensity distribution and compared with the corresponding threshold value; and, thereupon, the “transparent pixel” (pixels with more than one peak) is detected, and if there is a “transparent pixel”, the maximum intensity “transparent pixel” is selected from all “transparent pixels” and the ratio is calculated based on the above formula characterizing the intensity distribution and compared with the corresponding threshold value. If the results of the two comparisons are the same, i.e., both detect or do not detect a transparent object, the detection or non-detection of the transparent object is confirmed; if the results of the two comparisons are different, the result of the second comparison (i.e., based on the calculation of the maximum intensity “transparent pixel”) prevails.

Transparent Object Detection Using iToF Sensor Data

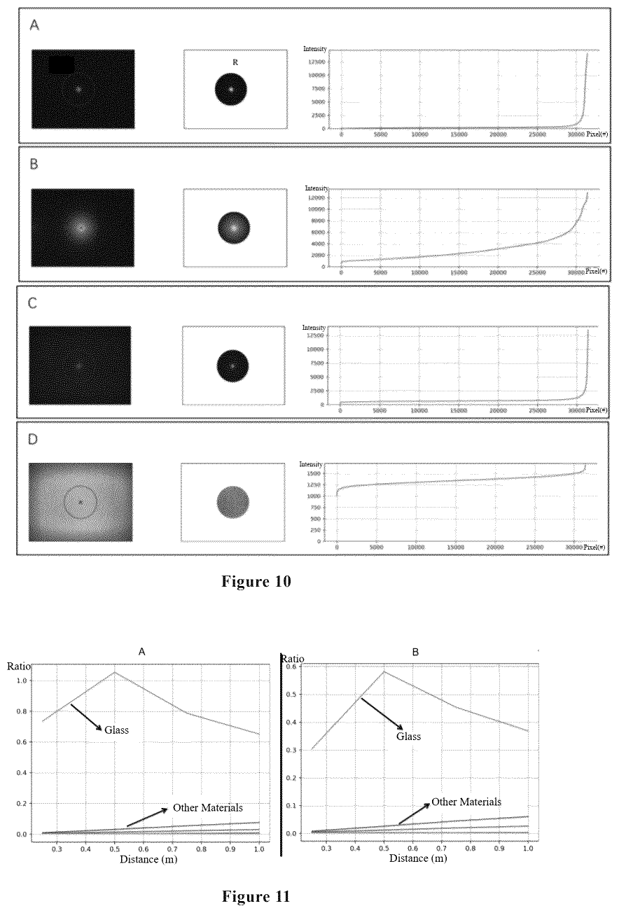

Similarly to the dToF sensor, the inventors have conducted imaging and analyzing on various materials including glass, by using an iToF sensor. Herein, the results for only four of these materials are shown for illustration. As shown in FIG. 10, A represents glass, B represents an elevator (elevator door surface), C represents marble, and D represents a white wall. The iToF sensor data for the surfaces of the above materials are obtained separately (as shown in the IR map in the left column of FIG. 10). The IR signal IR (i.e., “intensity”) of all pixels in this IR map is obtained, and the highest intensity pixel is obtained therefrom. Optionally, it is also possible to use a confidence C image from the iToF sensor data and obtain the highest confidence C (i.e., “intensity”) pixel therefrom.

Similarly to the dToF sensor, a region surrounding that highest intensity pixel (for example, a region with a radius R centered on that highest intensity pixel) is selected as a selected region (as shown in the middle column of FIG. 10). In a particular example according to the present disclosure, an iToF sensor having a pixel array of 640*480 is used, and the range of R is set to be 60 to 160 pixels. The R shown in the middle column of FIG. 10 is 100 pixels. Of course, R is not limited to a particular value or range but can be adaptively changed according to different sensors and testing situations in the calculation of the predetermined threshold as will be described below.

The intensities of all pixels in the selected region shown in the middle column of FIG. 10 are sorted in order from low to high to obtain a distribution of intensities as shown in the right column of FIG. 10.

Different from the dToF sensor, the distribution of intensities of the iToF sensor is characterized using a ratio calculated according to Formula 4 below:

$$\frac{Max\_Intensity}{{( Quantile\_Intensity * distance )}^{2}} \qquad ( Formula 4 )$$

Max_Intensity in the above formula represents the maximum intensity in the intensity distribution map, Quantile_Intensity represents the quantile intensity, and distance represents the imaging distance of the iToF sensor from the target. Different materials are imaged at different distances, and multiple depth maps as well as intensity distribution maps corresponding to multiple distances are obtained, respectively. The ratios at the corresponding distances were calculated separately using Formula 4 above, and the results are shown in FIG. 11.

A in FIG. 11 shows the result using the median quantile, Median_Intensity, as Quantile_Intensity, and B in FIG. 11 shows the result using the 7th decile, 7^{th} decile_Intensity, as Quantile_Intensity. As shown in FIG. 11, the ratio for glass is significantly higher than a ratio of the other materials at each of the imaging distances. Therefore, similarly to the dToF sensor, a threshold or a range of thresholds may be selected for transparent object detection using the iToF sensor. When the ratio calculated by Formula 4 is greater than the selected threshold, a transparent object is present; conversely, no transparent object is present. In the particular example shown in FIGS. 10 and 11, the threshold range may be selected to be, for example, 0.2 to 0.6 (in the case of using the median quantile, Median_Intensity) or 0.1 to 0.3 (in the case of using the 7th quantile, 7^{th} decile_Intensity).

Similarly to the dToF sensor, more than two quantile intensities can also be selected to calculate the ratio. For example, Formula 5 below is used for the calculation when selecting the maximum value, the median quantile, and the 7th quantile.

$$( Formula 5 )$$

$$\frac{( Max\_Intensity )}{\begin{matrix}0.5 * {( Median\_Intensity * distance )}^{2} + 0.5 * ( 7 th decile\_Intensity * \\ {distance )}^{2}\end{matrix}}$$

The purpose of calculating a ratio using quantile values is to characterize the distribution of intensities of pixels. The present disclosure is not limited to the above-mentioned formulas, and any formula upon which the distribution of intensities as illustrated in the right column of FIG. 10 can be appropriately characterized can be used.

Similarly to dToF sensors, the threshold (range) obtained from a different iToF sensor may be different. The threshold (range) is pre-tested by the specific iToF sensor to be used and the threshold data obtained for that specific iToF sensor is stored in an electronic device or in an iToF sensor or a mobile apparatus having such an iToF sensor according to the present disclosure.

### [Differentiation Between Transparent Object and Edge]

When using the dToF Sensor to judge transparent objects as described above, there may be cases where a false detection occurs, i.e., a transparent object is detected even though no transparent object exists. This is due to the presence of edges (e.g., door frames, wall corners, etc.).

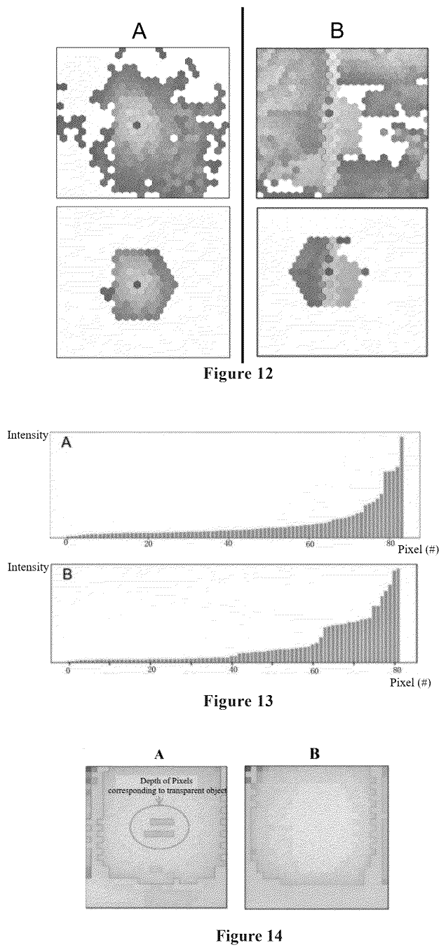

As illustrated in B and C in FIG. 2, when pixels with more than two peaks are detected, there are two possibilities, namely, a transparent object or an edge. Moreover, the inventors have found that the degree of variation in intensities of pixels for an edge is similar to the degree of variation in intensities of pixels for a transparent object to certain extent. Specifically, A of FIG. 12 illustrates a global pixel intensity map (upper part) and a pixel intensity map (lower part) based on a selected region (radius of R=5 pixels) surrounding the maximum intensity pixel of a transparent object (glass). B of FIG. 12 illustrates a global pixel intensity map (upper part) and a pixel intensity map (lower part) based on a selected region (radius of R=5 pixels) around the maximum intensity pixel of an edge (upper part). The intensities of pixels in the selected regions for the transparent object and the edge are ranked in descending order, and the results are shown in FIG. 13 (A represents the glass and B represents the edge). As shown in FIG. 13, the degree of variation in the intensities of pixels of the edge is to some extent similar to the degree of variation in the intensities of pixels of the transparent object.

As a result, the following situation may occur during the transparent object detection process, namely, pixels corresponding to a portion of an edge are obtained in the determined global maximum intensity pixels, and when the degree of variation of the intensities of pixels is calculated, the calculation result is also greater than a threshold value. Thereby, the edge will be incorrectly determined as a transparent object.

To solve the above problem, the inventors propose to utilize moment of inertia to differentiate between edges and transparent objects.

Although the degree of variation in intensities of pixels for the edge and for the glass in the selected region is similar to some extent, the distribution of the positions of pixels with different intensities in the intensity map (also the distribution of the positions of pixels with similar intensities in the intensity maps) for the edge and for the glass is clearly different, as shown in FIG. 12, where the shade difference in the grayscale maps shown in FIG. 12 indicates that the pixels are different in their intensities. This difference can be characterized by the moment of inertia. The moment of inertia is derived from rigid body mechanics and represents the inertia of an object as it rotates around an axis. The moment of inertia provides the distribution of mass around the principal axis. The moment of inertia I is given by the following equation:

$$I = \sum {mr}^{2}$$

where m denotes the mass of a particle and r denotes the distance of the particle from the principal axis of rotation.

The inventors propose that the moment of inertia may be applied to the field of two-dimensional image, i.e., the moment of inertia I is utilized to characterize the distribution of the positions of pixels with different intensities in a two-dimensional pixel intensity map, as illustrated in FIG. 12. In this case, m will denote the intensity of each pixel. As illustrated on the lower part of FIG. 12, compared to glass, pixels with similar intensities are distributed substantially along the axis in the intensity map of the edge, which is similar to the mass distribution of a bar or a long ellipsoid. While the distribution of pixels with similar intensities for glass is distributed substantially around the center region, which is substantially similar to the mass distribution of a sphere. Therefore, the inventors propose that the moment of inertia of the long ellipsoid can be used to characterize and distinguish the positional distribution of pixels of different intensities of the two. The moment of inertia of the long ellipsoid depends on three semi-axes.

Since the intensity map to be characterized according to the present disclosure is two-dimensionally planar, the moment of inertia will depend on two half-axes in the plane, i.e., the two principal axes of rotation, denoted by x and y, where y is the longer axis. The distribution of intensities around these two principal axes of rotation is defined by Iₓ and I_{y}:

$${I}_{x} = \sum {mr}_{y}^{2}$$

where m denotes the intensity of each pixel and r_{y} denotes the distance between the pixel and the principal axis y of rotation.

Similarly,

$${I}_{y} = \sum {mr}_{x}^{2}$$

where m denotes the intensity of each pixel, rₓ denotes the distance between the pixel and the principal axis x of rotation, I_{y}>Iₓ.

A comparison of the ratio calculated from

$$\frac{{I}_{y}}{{I}_{x}}$$

with the inertia threshold may distinguishes the glass from the edge. When

$$\frac{{I}_{y}}{{I}_{x}}$$

is greater than or equal to the inertia threshold, it is determined that an edge is detected instead of a transparent object. The inertia threshold may be predetermined. In accordance with a particular example as shown in FIG. 12, a region from the intensity map with a radius of R (R=5 pixels) centered on the maximum intensity pixel is selected to determine the inertia threshold. The range of this selected region is not limiting, but generally it is consistent with the selected region as described above for transparent object detection utilizing the degree of variation of the intensities in the selected region. Of course, a region different from the selected region for the transparent object detection may also be used as long as the positions distribution of the edge and the transparent object can be appropriately characterized in purpose for differentiation. The ratio of the rotational inertia I_{y} to Iₓ,

$$\frac{{I}_{y}}{{I}_{x}} ,$$

for the selected regions of the glass and the edge shown on the lower part in FIG. 12, is respectively calculated.

If the ratio of I_{y} to Iₓ,

$$\frac{{I}_{y}}{{I}_{x}} ,$$

is close to 1, it indicates that pixels of different intensities are uniformly distributed around a center point, similar to the mass distribution of a flat disk. If the ratio of Iy to Ix,

$$\frac{{I}_{y}}{{I}_{x}} ,$$

is greater than 3 or 4, it indicates that the intensities are distributed along an axis, which can be judged as an edge rather than a glass. Accordingly, in a particular example, the present disclosure sets the threshold at 3.0 or 4.0, but the threshold is not limiting. In implementing the present disclosure, the threshold may be predetermined and stored based on the specific ToF sensor to be used and/or the specific test situation. Similarly to the ratio thresholds, the inertia thresholds are also stored in the electronic device of the present disclosure. Optionally, it may also be stored in a ToF sensor or a mobile apparatus (e.g., cell phone, camera, self-moving robot, vehicle, VR glasses/headset, etc.) that includes a ToF sensor.

As described above, by utilizing a comparison of the moment of inertia with a threshold value, it is possible to correct the fault glass detection due to the presence of edges.

[Transparent Object Detection and Depth Map Correction by dToF Sensors]

FIG. 14 illustrates a particular example of a depth map obtained by a dToF sensor. When there is a transparent object in the imaging target or in the imaging path (as shown in B and C of FIG. 2), the transparent object may partially appear in the depth map obtained by the ToF sensor. That is, as circled in A of FIG. 14, a “floating point” (corresponding to the pixel depth of the transparent object) may appear in the center region of the pixel depth map. If this depth map is used, for example, for the camera's autofocus, it will incorrectly focus on the transparent object instead of the background (i.e., the imaging target). Also, if the depth map is used for ranging, the distance to the transparent object will be incorrectly obtained instead of the distance to the target in the background.

Therefore, it is desired to detect whether a pixel depth corresponding to a transparent object exists in the pixel depth map. If a transparent pixel is detected, it is desirable to remove the depth of the transparent pixel from the depth map so as to obtain a corrected depth map (as shown in B of FIG. 14).

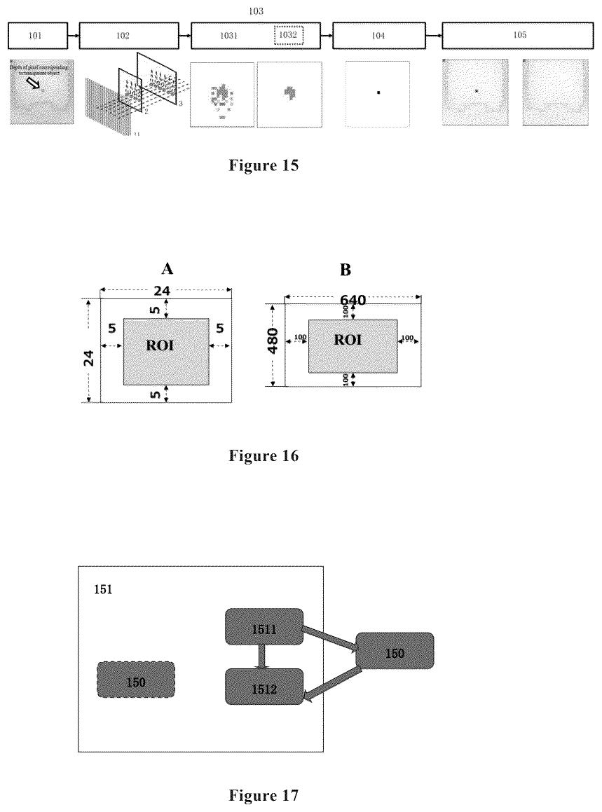

A transparent object may be detected by steps as shown in FIG. 15, and the depth map may be corrected as needed.

### [Transparent Object Detection]

First, in step 101, an image of the target, including a depth map, such as the depth map shown in 101, and other TOF data, such as a pixel histogram and a pixel intensity map, may be acquired using the dToF sensor. Histogram data for all pixels is acquired from the target image. Preferably, a Region Of Interest (ROI) in the target image may be intercepted and histogram data of all pixels in the region of interest is obtained. In a particular example according to the present disclosure, a dToF sensor with a pixel array of 24*24 as shown in A in FIG. 16 is used, and in that case, the ROI may be selected as a region that is 5 pixels away from each edge of the pixel array. In another particular example according to the present disclosure, an iToF sensor having a pixel array of 640*480 as shown in B in FIG. 16 is used, and in that case, the ROI may be selected as a region that is 100 pixels away from each edge of the pixel array. Obviously, the selection of the ROI is not limited to the above examples, but may be selected based on the specific ToF sensor to be used based on the actual situation, so as to avoid that the maximum intensity pixel fails to be from the target located in the center of the image.

Further, in step 101, when the dToF sensor is used, the acquired pixel histogram data is preprocessed (not shown) to remove a peak in the histogram that are very close to the start time, i.e., a peak that corresponds to the camera cover glass. Alternatively, if two peaks appear at a position very close to the start time in the histogram, this may be due to the fact that the camera uses a double-layer cover glass. In this case, if the distance between the two peaks is less than a predetermined threshold (e.g., 20 mm), the two peaks are considered to be the peaks corresponding to the cover glass and are removed from the histogram data.

As shown in FIG. 102, if there is a transparent object 2 (corresponding to C in FIG. 2) in the imaging path, there will be pixels with more than one peak in the pixel array 11 of the dToF sensor. In step 102, all pixels having more than one peak (i.e., presumed “transparent pixels”) are detected and acquired. Next, in step 103, a transparent object is detected. The “transparent pixel” having the maximum intensity among the presumed “transparent pixels” is detected. Preferably, the “transparent pixel” having the maximum intensity in the region of interest ROI of the target image is detected. Next, a selected region surrounding the “transparent pixel” with the maximum intensity is selected, such as a region centered on the “transparent pixel” with the maximum intensity and with a radius R. In a particular example according to the present disclosure, a pixel array of 24*24 is used, and R is set in a range of 3 to 8 pixels, for example, R may be selected to be 2, 3, or 5. However, as explained above in the principle of transparent object detection, the selection of R is based on the specific ToF sensor used and is not limited to a particular value or range. Intensities of all pixels in the selected region are obtained and sorted to obtain the distribution of intensities of the pixels in the selected region. A ratio characterizing a degree of variation in the intensities of the pixels within the selected region is calculated (by Formula 1 for example), and the presence or absence of a transparent object is determined based on a comparison of the ratio with a pre-stored predetermined threshold, see the above section “Principle for Transparent Object Detection” for more details which will not be repeated here. In addition, the value of R used by the ToF sensor for transparent object detection is generally the same as the value of R used for determining a predetermined threshold value.

The case of B in FIG. 2 is not illustrated in step 2. However, in the transparent object detection method described above for C of FIG. 2, the selection of “transparent pixel” (i.e., pixel having more than one peak) with the maximum intensity is not limited to the selection of “transparent pixels” whose first peak is the maximum intensity. Therefore, the above-mentioned transparent object detection method is also applicable to transparent object detection in the case of B in FIG. 2.

The case of A in FIG. 2A, where a transparent object is present but the background object (target) cannot be detected by the ToF sensor because it is too far away, is not illustrated in step 102. In this case, the preprocessed pixel histogram obtained by the ToF sensor will have only one peak. At that time, in step 103, the pixel with the highest peak of the pixel histogram is used as the maximum intensity pixel. Preferably, the pixel with the highest peak of the pixel histogram within the ROI of the target image is used as the maximum intensity pixel. Then, a region surrounding the maximum intensity pixel, such as a region centered on the maximum intensity pixel and having a radius R, is selected as the selected region. Next, in a manner similar to the above-described selected region centered on the maximum intensity “transparent pixel,” a ratio characterizing a degree of variation in the intensities of pixels in the selected region is calculated by, for example, Formula 1 and whether or not a transparent object exists in the image captured by the ToF sensor is determined based on a comparison of the ratio with a predetermined threshold.

In brief, in the transparent object detection using the dToF sensor in step 101, only the global maximum intensity pixel is selected as the maximum intensity pixel. In the case where a “transparent pixel” exists, either of the global maximum intensity pixel and the maximum intensity “transparent pixel,” and preferably, the maximum intensity “transparent pixel,” may be selected.

Preferably, in the case where a “transparent pixel” is present, a maximum intensity pixel is first selected from the global pixel intensity data of all pixels of the target image, and then the above-described selected region is obtained based on the maximum intensity pixel, and a ratio is calculated based on the above-described formula characterizing the distribution of the intensities, which is then compared with the corresponding threshold value. Further, “transparent pixels” (pixels having more than one peak) within the target image are detected, and if there are “transparent pixels,” the maximum intensity “transparent pixel” is selected from among all “transparent pixels,” and then the above selected region is obtained based on the maximum intensity “transparent pixel”, and a ratio is calculated based on the above formula for characterizing the distribution of intensities, and then is compared with the corresponding threshold. If the results of the two comparisons are the same, i.e., both detect or do not detect a transparent object, the detection or non-detection of the transparent object is confirmed; if the results of the two comparisons are different, the result of the second comparison (i.e., the calculation based on the maximum intensity “transparent pixel”) prevails.

Alternatively, in step 103, the result of detecting a transparent object may be corrected using the moment of inertia to avoid the fault transparent object detection due to edges. Specifically, when it is determined the presence of a transparent object in step 103, the moment of inertia, Ix and Iy, of the selected region are calculated, and

$$\frac{{I}_{y}}{{I}_{x}}$$

is compared to a pre-stored inertia threshold. If

$$\frac{{I}_{y}}{{I}_{x}}$$

is greater than or equal to the inertia threshold, it is determined that there is no transparent object present (but rather an edge is detected), and the result of the transparent object detection in step 103 is then corrected.

Also, FIG. 15 does not illustrate the iToF sensor to detect a transparent object. When the iToF sensor is used, TOF image data obtained by the iToF sensor from imaging the target may be acquired, including an infrared map, a confidence C image, and an intensity map formed by the confidence C or the IR signal (i.e., the intensity) of each pixel in the pixel array. Based on the intensity map data, pixels having the highest intensity therein are determined. Preferably, a pixel having the highest intensity within the ROI of the target image is detected and determined.

Next, similarly to the dToF sensor, a region surrounding the highest intensity pixel is selected as the selected region, such as a region with a radius R centered on the highest intensity pixel. In a particular example according to the present disclosure, an iToF sensor having a pixel array of 640*480 is used and R may be selected in a range of 60 to 160 pixels, for example, R=100. However, as mentioned above in the principle of detecting a transparent object using the iToF sensor, the selection of R is dependent on the pixel array of the particular iToF sensor used and is not limited to a particular value or range. Then, the intensities of all the pixels in the selected region are obtained and arranged in order from low to high to obtain the distribution of intensities of pixels of the selected region. Next, a ratio characterizing the degree of variation of the intensities of pixels within the selected region is calculated by, for example, Formula 4, and the presence or absence of a transparent object within the image is judged based on a comparison of the ratio with a pre-stored predetermined threshold. Further, similarly to the dToF sensor, the value of R used by the iToF sensor in performing the detection of a transparent object generally corresponds to the value of R used in determining the predetermined threshold of the iToF sensor.

[Correction on Depth Map of dToF Sensor]

In the case where the depth map obtained using the dToF sensor have a pixel with more than one peak, the result of the transparent object detection can be utilized to perform depth map correction, i.e., to remove the depth of pixels in the depth map that indicate the transparent object.

Specifically, all pixels having more than one peak in the image captured by the dToF sensor are selected, and when a transparent object is detected in step 103 according to FIG. 15, a pixel corresponding to the transparent object is selected in step 104 from among all pixels having more than one peak. The pixels corresponding to the transparent object may include a case as shown in \textcircled{2} of the right part of row C in FIG. 2, i.e., the peak of the transparent object (the first peak) is the maximum peak, and/or a case as shown in \textcircled{2} of the right part of row B in FIG. 2, i.e., the peak of the transparent object (the first peak) is a non-maximum peak.

Then, as shown in 104, one or more pixels whose first peak is the maximum peak thereof is acquired from those pixels corresponding to the transparent object. Next, in step 105, the first peak of the one or more pixels is removed from the left image shown in 105 and other peaks of the one or more pixels are retained. Preferably, the second peak of the one or more pixels is used as the depth data for that pixel(s) in the depth map. Further preferably, the one pixel from which the first peak is the highest intensity in the intensities of the one or more pixels may be further selected, and the first peak of this pixel is removed from the depth map, thereby obtaining a corrected depth map as shown in the right image of 105.

In the above manner, the depth map in the case as shown in \textcircled{2} on the right part of row C in FIG. 2 was corrected. The depth map thus corrected is advantageous for the depth map-based autofocus, which focuses on the maximum intensity pixels.

Optionally, the first peaks of the pixels corresponding to the transparent object is removed directly from the depth map. Thus, the depth of the transparent object is corrected in either of the cases shown in \textcircled{2} of the right part of rows B and C in FIG. 2. The depth map after removing the depth of a transparent object in this manner is also useful in, for example, autofocus and distance measurement. In addition, when a transparent pixel is detected, preferably, as shown in step 1031, all pixels having more than one in the image may be regrouped with respect to the same or similar distances (corresponding to depths in the depth map) to obtain a plurality of pixel clusters corresponding to different distances respectively, as shown in 1031. The pixels in a cluster having the same or similar distance may be determined based on the location of a time bin corresponding to the peak in the pixel histograms, i.e., pixels in the same cluster have a peak at the same or similar time bin. Next, a cluster corresponding to the transparent object is selected from the plurality of pixel clusters, as shown in 1032. Next, in step 104, similarly to the above, one or more pixels whose first peak is the maximum peak are obtained from the cluster corresponding to the transparent object. The one or more pixels is the pixel or pixels to be corrected for depth, as shown in 104. Then, in step 105, the first peak of the pixel or pixels whose depth is to be corrected is removed from the image, i.e., a peak other than the maximum peak of the pixel whose depth is to be corrected is used in the depth map. Preferably, in a particular example according to the present invention, a second peak is used. Still preferably, similarly to the above, the pixel from which the first peak is the highest intensity of the intensities of the one or more pixels may be further selected and the first peak of this pixel is removed from the depth map, thereby obtaining a corrected depth map as shown in the right image of 105. As a result, the depth of the pixel corresponding to the depth/distance of the transparent object is removed from the original image (left image of 105) to obtain the corrected depth map (right image of 105) in FIG. 15.

The effect of transparent object can be removed due to the corrected depth map.

### [Electronic Device of the Present Disclosure]

FIG. 17 illustrates an electronic device 150 according to the present disclosure, which may be implemented as an electronic module that performs the detection of transparent object described above. The electronic device 150 may be in communication with a ToF sensor device 1511 to receive data acquired by the ToF sensor device 1511. The ToF sensor device 1511 may be an dToF sensor or an iToF sensor and may be included in a mobile apparatus 151. The mobile apparatus 151 is, for example, a camera, a cell phone, a self-moving robot, a vehicle, and other movable apparatus having an image device. The electronic device 150 may also be directly implemented as a ToF sensor device. That is, the ToF sensor device 1511 may itself include the electronic device 150 of the present disclosure. Alternatively, the electronic device 150 may be included in the mobile apparatus 151, as shown by the dashed box in FIG. 17.

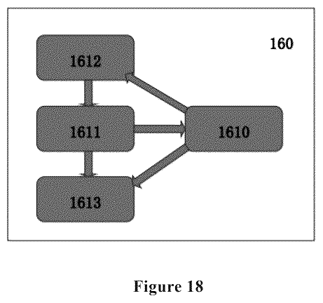

The transparent object detection of the circuit module in the electronic device 150 is based on TOF data received from the ToF sensor device 1511, such as a pixel histogram, a pixel intensity map and a depth map, received from the dToF sensor, or a confidence image, an infrared image, a pixel intensity map received from the iToF sensor. Then, the circuit module obtains from the received data the intensities of all pixels in a selected region of the image and determines whether there is a transparent object in the imaging target/path based on the degree of variation in the intensities of pixels in the selected region. The circuit module in the electronic device 150 may correct the depth map obtained from the ToF sensor device 1511 based on the result of detecting the transparent object in a manner as described with respect to FIG. 15, and send the corrected depth map to the processing circuit 1512 for subsequent processing. Optionally, the electronic device may directly send the result to the processing circuit 1512, and the processing circuit 1512 will perform subsequent processing based on the result. For example, the processing circuit 1512 may correct the depth map of the target by removing a pixel depth indicating a transparent object from the depth map based on the result of detecting the transparent object. Further, the processing circuitry 1512 performs subsequent processing based on the corrected depth. For example, where the mobile device 151 is implemented as a camera or a cell phone, while it is taking a picture, the processing circuitry 1512 may instruct the imaging device of the camera or the cell phone to perform autofocus based on the judging result received from the electronic device 150, as will be described in detail below based on FIG. 18. The mobile device 151 may also be implemented as a vehicle. At this time, the processing circuitry 1512 may remove a depth indicating the distance of the transparent object from the depth map of the ToF sensor device 1511 based on the judging result of detecting the transparent object received from the electronic device 150, and thus determine for example a distance between the vehicle and the target object based on the corrected depth map. In the case where the mobile device 151 is implemented as a self-moving robot, the processing circuitry 1512 may determine the presence or absence of a transparent object on the travel route of the robot based on the judging result received from the electronic device 150. Where the judging result indicates that a transparent object is detected, the processing circuitry 1512 may, for example, bypass the transparent object when planning a travel route of the self-moving robot.

The mobile device 151 may also be implemented as virtual reality VR glasses/helmet. At this time, the processing circuit 1512 may determine that the target is a transparent object based on the judging result of detecting the transparent object received from the electronic device 150, and continue walking or operating by bypassing the transparent object. The processing circuit 1512 may further determine a distance from the real target based on the judging result.

[Cell Phone with ToF Sensor]

FIG. 18 illustrates a mobile apparatus 160 which is implemented as a cell phone (e.g., a smartphone) and which includes an electronic device implemented as a circuit module (transparent object detection module) 1610, an imaging module 1611, an autofocus AF module 1612, and a ranging module 1613. The imaging module 1611 includes an imaging device such as a ToF sensor, an RGB image sensor.

The transparent object detection module 1610 receives pixel data from the ToF sensor in the imaging module 1611 and performs a transparent object detection function according to the present disclosure as described above. The transparent object detection module 1610 sends the detection result to the autofocus module 1612, and the autofocus module switches the autofocus method based on the judging result. For example, if the circuit module 1610 receives from the ToF sensor a pixel histogram having only one peak (note that the peak corresponding to the camera cover glass has been removed by preprocessing, as previously described) and the detection result based on the pixel histogram indicates the presence of a transparent object, it may be determined that there is a transparent object in the imaging target/path and that the imaging target (the background object) is too far away to be detected by the dToF sensor. Then, the AF module 1612 will use other autofocus methods, such as CDAF, based on this judging result.

In particular, when the circuit module 1610 detects a pixel having more than one peak from the data received from the ToF sensor and the detection result indicates the presence of a transparent object, the circuit module 1610 may correct the depth data obtained by the ToF sensor based on the detection result (i.e., removing the depth of pixels that indicate the transparent object in the depth map), and send the corrected depth data to the autofocus module 1612. The autofocus module 1612 performs autofocus based on this corrected depth data.

The transparent object detection module 1610 may also send the detection result to the ranging module 1613, and the ranging module 1613 performs a distance measurement function based on the detection result. In the case where a transparent object is detected, the distances of the transparent object and the target may be obtained separately. In contrast, in the prior art of ToF ranging, when 1 pixel with 2 peaks occurs, a depth (distance) can only be determined by such as fusion or discard, because it cannot be determined what objects are the two peaks respectively. Whereas, by using the method of the present disclosure, in the case of multiple peaks, the distance of the transparent object and the distance of the target can be clearly determined, and preferably the transparent object or the edge can also be distinguished and the distance of the edge and the distance of the target can be determined.

The transparent object detection module 1610 may process the depth map obtained by the ToF sensor based on the detection result of detecting a transparent object to correct the depth map when the transparent object is detected. The transparent object detection module 1610 may send the corrected depth data to the AF module 1612, and the AF module 1612 performs autofocus based on the corrected depth data. The transparent object detection module 1610 may also send the corrected depth data to the ranging module 1613 for the ranging module 1613 to perform a ranging function.

As described above, the electronic device according to the present disclosure is capable of performing transparent object detection based on data obtained from a ToF sensor. Although transparent object detection has been described above primarily in terms of depth map correction and autofocus, the application of the electronic device of the present disclosure is not limited thereto, but is capable of being applied to any computer vision task that requires the determination of transparent objects in a scene.

It should be understood by those skilled in the art that there can be various modifications, combinations, sub-combinations, and substitutions depending on design needs and other factors, without departing from the spirit of the present disclosure.

1-27. (canceled)

28. An electronic device, comprising a circuitry configured to
obtain data of reflected radiation received in each pixel of an image captured by a ToF sensor,
determine, based on the data of reflected radiation of each pixel in a first region of the image, a distribution of intensities of pixels in the first region, the intensity representing a peak of the data of reflected radiation of the pixel, and
judge whether the image comprises a transparent object based on the distribution of intensities.

29. The electronic device according to claim 28, wherein the circuitry is further configured to
determine a degree of variation of the intensities of pixels in the first region according to the distribution of intensities, and
judge whether the image comprises the transparent object based on the degree of variation.

30. The electronic device according to claim 29, wherein the circuitry is configured to
judge the image comprises the transparent object when the degree of variation is higher than a predetermined threshold;
judge the image doesn't comprise the transparent object when the degree of variation is lower than or equivalent to the predetermined threshold.

31. The electronic device according to claim 30, wherein the circuitry is configured to determine the degree of variation according to a maximum intensity Max_Intensity and at least one quantile intensity Quantile_Intensity in the intensities of pixels in the first region.

32. The electronic device according to claim 30, wherein the circuitry is configured to determine the degree of variation according to a maximum intensity Max_Intensity and one quantile intensity Quantile_Intensity in the intensities of pixels in the first region.

33. The electronic device according to claim 32, wherein the ToF sensor is a dToF sensor, and the degree of variation is defined as a ratio calculated by
$$\frac{Max\_Intensity}{{Quantile\_Intensity}^{2}} .$$

34. The electronic device according to claim 32, wherein the ToF sensor is an iToF sensor, and the degree of variation is defined as a ratio calculated by
$$\frac{Max\_Intensity}{{( Quantile\_Intensity * distance )}^{2}} ,$$
wherein distance refers to a capturing distance of the iToF sensor.

35. The electronic device according to claim 28, wherein the circuitry is further configured to:
detect a max intensity pixel in the image, and
determine a selected area surrounding the max intensity pixel as the first region.

36. The electronic device according to claim 28, wherein the circuitry is further configured to:
detect a max intensity pixel in a region of interest in the image, and
determine a selected area surrounding the max intensity pixel as the first region.

37. The electronic device according to claim 28, wherein the ToF sensor is a dToF sensor, a peak in a histogram of pixel in the dToF sensor corresponds to the intensity, and wherein the circuitry is further configured to
detect, from the image, one or more pixels with more than one peak in the histograms,
select a max intensity pixel from the one or more pixels, and
determine a selected area surrounding the max intensity pixel as the first region.

38. The electronic device according to claim 37, wherein the circuitry is further configured to:
select the max intensity pixel from pixels with more than one peak in a region of interest in the image.

39. The electronic device according to claim 28, wherein the circuitry is further configured to
determine a position distribution of pixels with different intensities in the first region when a result of the judging shows detection of a transparent object, and
correct the result of the judging based on the position distribution.

40. The electronic device according to claim 39, wherein the circuitry is further configured to determine the position distribution by calculating
$$\frac{{I}_{y}}{{I}_{x}} ,$$
wherein Iₓ=Σmr_{y}², I_{y}=Σmrₓ², m is an intensity of each of the pixels in the first region, rₓ is a distance from the pixel to a first principal axis x of rotation of the first region, r_{y} is a distance from the pixel to a second principal axis y of rotation of the first region, and I_{y}>Iₓ.

41. The electronic device according to claim 40, wherein when
$$\frac{{I}_{y}}{{I}_{x}}$$
is larger than or equivalent to a predetermined threshold, the circuitry is configured to determine that there is no transparent object, and correct the result of the judging.

42. The electronic device according to claim 28, wherein the circuitry is further configured to, before determining the distribution of intensities, pre-process the data of reflected radiation of each pixel to remove a data of reflected radiation representing a cover glass of the ToF sensor.

43. The electronic device according to claim 28, wherein the ToF sensor is a dToF sensor, a peak in a histogram of pixel in the dToF sensor corresponds to the intensity, and wherein the circuitry is further configured to:
get all pixels with more than one peak in the image, when the result of judging shows detection of transparent object,
regroup the all pixels with more than one peak into a plurality of clusters based on distance data of pixels in the image, the plurality of clusters corresponding to different distances respectively,
select a cluster from the plurality of clusters that correspond to the transparent object as a transparent object cluster, and
remove the first peak of a pixel in the transparent object cluster from the image or output a depth corresponding to the first peak of a pixel in the transparent object cluster as a distance to the transparent object and output a depth corresponding to a second peak of a pixel in the transparent object cluster as a distance to a target.

44. The electronic device according to claim 28, wherein the electronic device is implemented as the ToF sensor.

45. An electronic device, comprising a circuitry configured to:
obtain a histogram of each pixel in an image captured by a dToF sensor,
get all pixels with 2 peaks in the histogram,
obtain a first set of pixels from the all pixels with 2 peaks, the first set of pixels being pixels where first peak is the highest peak, and
remove the first peaks of the first set of pixels from the image.

46. The electronic device according to claim 45, wherein the circuitry is further configured to, before getting the all pixels with 2 peaks, pre-process the histogram of each pixel to remove a peak representing a cover glass of the dToF sensor from histogram.

47. The electronic device according to claim 45, wherein the circuitry is further configured to:
select, from the all pixels with 2 peaks, pixels corresponding to a transparent object, and
select, from the pixels corresponding to a transparent object, one or more pixels with the first peak being the highest peak, as the first set of pixels.
